(19) United States
(12) Patent Application Publication
(10) Pub. No.: US 2022/0217620 A1
(43) Pub. Date: Jul. 7, 2022

(54) CONTROLLING NETWORK ACCESS

(71) Applicant: Nokia Technologies Oy, Espoo (FI)

(72) Inventors: Teemu Petteri HIMANEN, Oulu (FI); Juho Emil Eskonpoika KOKKONEN, Oulu (FI)

(21) Appl. No.: 17/595,467

(22) PCT Filed: Apr. 28, 2020
(86) PCT No.: PCT/EP2020/061732

§ 371 Date: Nov. 17, 2021

(30) Foreign Application Priority Data
May 20, 2019 (FI) 20195413

(51) Int. Cl. H04W 48/16; H04W 28/24; H04W 48/18; H04W 4/02

(52) U.S. Cl. CPC H04W 48/16; H04W 4/025; H04W 48/18; H04W 28/24

(57) ABSTRACT

Apparatus and method for controlling network access are disclosed. The solution comprises obtaining (400) information on one or more network slices of the communication system configured to serve user terminals and geographical areas where a network slice is available, the areas being within one or more tracking areas of the communication system; obtaining (402) information on the geographical location of a user terminal; and activating (404) one or more network slices for the user terminal if the user terminal is located within the geographical area where the network slices are available.

### TECHNICAL FIELD

The exemplary and non-limiting embodiments of the invention relate generally to communications.

### BACKGROUND

Wireless telecommunication systems are under constant development. There is a constant need for higher data rates and high quality of service. Reliability requirements are constantly rising and ways and means to ensure reliable connections and data traffic while keeping transmission delays minimal are constantly under development.

Developing networks enable new services to customers. One suggested service is Network Slicing, which enables offering connectivity, quality of service and data processing solutions tailored to specific customers' requirements. A network slice is a logical end-to-end virtual network that can be dynamically created and that provides specific capabilities and characteristics. Multiple network slices may be created on top of a common shared physical network infrastructure to run services that may have different requirements on latency, reliability, throughput and mobility. Currently, a network slice and the service it provides for a user terminal are consistent throughout a tracking area of the network. A tracking area itself is at minimum the size of a physical radio cell and can span over several radio cells and a large geographical area.

### BRIEF DESCRIPTION

According to an aspect of the present invention, there is provided an apparatus of claim 1.

According to an aspect of the present invention, there is provided a method of claim 10.

One or more examples of implementations are set forth in more detail in the accompanying drawings and the description below. Other features will be apparent from the description and drawings, and from the claims.

### BRIEF DESCRIPTION OF THE DRAWINGS

In the following the invention will be described in greater detail by means of preferred embodiments with reference to the accompanying drawings, in which

FIGS. 1 and 2 illustrate examples of communication environments where some embodiments of the invention may be applied;

FIG. 3 illustrates an example of a tracking area;

FIG. 4 is a flowchart illustrating an embodiment of the invention;

FIGS. 5A and 5B illustrate examples of geographical areas of a network slice;

FIGS. 6 and 7 are flowcharts illustrating some embodiments of the invention; and

FIG. 8 illustrates an example of an apparatus employing some embodiments of the invention.

### DETAILED DESCRIPTION OF SOME EMBODIMENTS

In the following, different exemplifying embodiments will be described using, as an example an access architecture to which the embodiments may be applied, a radio access architecture based on long term evolution advanced (LTE Advanced, LTE-A), enhanced LTE (eLTE), or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), or any combination thereof.

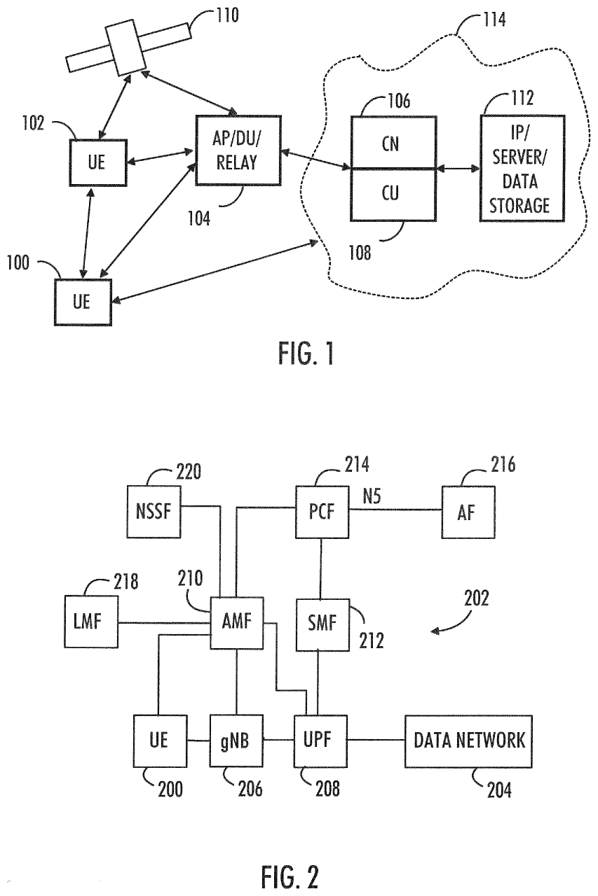

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for data and signaling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 106 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), User Plane Function (UPF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. One technology in the above network may be denoted as narrowband Internet of Things (NB-lot). The user device may also be a device having capability to operate utilizing enhanced machine-type communication (eMTC). The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, perhaps more base stations or nodes than the LTE (a so-called small cell concept), including macro sites operating in co-operation with smaller stations and employing a variety of radio technologies depending on service needs, use cases and/or spectrum available. 5G mobile communications support a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, above 6 GHz-mmWave). As mentioned, one of the concepts considered to be used in 5G networks is network slicing in which multiple independent and dedicated virtual sub-networks (network instances) may be created within the same infrastructure.

The current architecture in LTE networks is fully distributed in the radio and fully centralized in the core network. The low latency applications and services in 5G require to bring the content close to the radio which leads to local break out and mobile edge computing. 5G enables analytics and knowledge generation to occur at the source of the data. This approach requires leveraging resources that may not be continuously connected to a network such as laptops, smartphones, tablets and sensors. Mobile edge computing provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

In an embodiment, 5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 110 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

As mentioned, radio access network may be split into two logical entities called Central Unit (CU) and Distributed Unit (DU). In prior art, both CU and DU supplied by the same vendor. Thus, they are designed together and interworking between the units is easy. The interface between CU and DU is currently being standardized by 3GPP and it is denoted F1 interface. Therefore, in the future the network operators may have the flexibility to choose different vendors for CU and DU. Different vendors can provide different failure and recovery characteristics for the units. If the failure and recovery scenarios of the units are not handled in a coordinated manner, it will result in inconsistent states in the CU and DU (which may lead to subsequent call failures, for example). Thus there is a need to enable the CU and DU from different vendors to coordinate operation to handle failure conditions and recovery, taking into account the potential differences in resiliency capabilities between the CU and DU.

FIG. 2 illustrates an example of a communication system based on 5G network components. A user terminal or user equipment 200 communicating via a 5G network 202 with a data network 204. The user terminal 200 is connected to a base station or gNB 206 which provides the user terminal a connection to data network 204 via one or more User Plane Functions 208. The user terminal 200 is further connected to Core Access and Mobility Management Function, AMF 210, which is a control plane core connector for (radio) access network and can be seen from this perspective as the 5G version of Mobility Management Entity, MME, in LTE. The 5G network further comprises Session Management Function, SMF 212, which is responsible for subscriber sessions, such as session establishment, modify and release and a Policy Control Function 214 which is configured to govern network behavior by providing policy rules to control plane functions. The network may further comprise an Application Function, AF, 216 connected to PCF 214, the AF controlling applications that require deterministic communication and defines the schedule on which all TSN frames are transmitted when Time Sensitive Networking, TSN is utilized in the network.

According to a 3GPP (The 3rd Generation Partnership Project) functional specification of user terminal positioning in 5G radio access network, a positioning functionality in the network is configured to provide a way to determine the geographic position and/or velocity of a user terminal based on measuring radio signals. The position information may be requested by and reported to a client (such as an application) associated with the user terminal or by a client within or attached to the core network.

High accuracy positioning of user terminal is becoming more and more essential in the developing networks. The reason for this is that tracking of mobile devices as well as mobile assets is becoming increasingly important in improving processes and increasing flexibility in industrial environments, for example. Therefore positioning capabilities have been taken into account in the development of the communication networks, such as 5G or New Radio. Thus, 5G and other developing networks will provide various positioning services, supported by different single and hybrid positioning methods to supply absolute and relative positioning. In addition, positioning information shall be acquired in a timely fashion, be reliable, and be available for parties needing the information in a safely manner.

Thus, the network further comprises a Location Management Function, LMF, 218 connected to AMF. The LMF is the network entity in the network which supports the location related operations, such as location determination for a user terminal, downlink location measurements or a location estimate from the user terminal, uplink location measurements from the radio access network and non-UE associated assistance data from the radio access network.

The network may further comprise a Network Slice Selection Function, NSSF, 220, which is configured to maintain information on network slices of the communication system.

It may be noted that the above described network components may be realized with various physical hardware. Each component may be realized with a one or more separate hardware components or some network components may be realized using common physical hardware, as one skilled in the art is aware.

As mentioned. network slicing is a concept where network resources of an end-to-end connection between a user terminal and another end point in a public land mobile network (PLMN) are sliced. Similar network slicing may be employed also in private networks. A network slice may be understood as a logical end-to-end network that can be dynamically created and/or modified. The network(s) between the end devices may all be sliced from one end device to the other end device, the slices thus forming logical pipelines within the network(s). User terminal may access a slice over a radio interface. Each pipeline/slice may serve a particular service type. So far, three different network slice/service types have been standardized: eMBB (slice suitable for the handling of 5G enhanced Mobile Broadband), URLLC (slice suitable for the handling of ultra-reliable low latency communications) and MIoT (slice suitable for the handling of massive Internet of Things). Communications Service Providers (CSPs) are able to define additional network slice/service types if needed. A given user terminal may access to multiple slices over the same Access Network (over the same radio interface, for example).

Thus, network slicing enables a communications service provider to provide dedicated virtual networks over a common network infrastructure. The different virtual or logical networks may be designed to provide different networking characteristics such as different qualities of service (QoS). For example, the virtual networks may be customized to meet specific needs of various applications, services, devices, customers and/or operators.

In a system where network slicing is utilized, a single physical network or a group of networks is sliced into multiple virtual networks (slices) that can support different radio access networks (RANs) or different service types running across a single RAN. The network slicing may be used to partition a core network of a cellular communication system such as a 5G system, but it may also be implemented in the RAN such as the WLAN.

Each network slice may be optimized to provide resources and network topology for the specific service and traffic that will use the slice. Network resources may be allocated according to requirements in terms of mobility, capacity, connectivity and coverage such that particular demands of each use case will be met. Physical network components or resources may be shared across different network slices.

Currently, a network slice and the service it provides for a user terminal are consistent throughout a tracking area (TA). A tracking area may be defined as a logical grouping of radio cells in LTE or 5G networks. A tracking area manages and represents the location of user terminals. A user terminal is registered and active in one tracking area and in one cell at a time and provided with a given number of network slices simultaneously. Currently the up to eight simultaneous network slices are supported. A tracking area can consist of multiple physical cells and the network slice is consistent through all of them. This means that two different user terminals which have registered to the same network slice type/service will have the same level of service within the tracking area consisting of one or more physical cells regardless of the specific locations of the user terminals inside the tracking area. A tracking area and hence a network slice might span a larger area for instance an industrial park with several enterprises and factories.

When several customers such as factories or any type of vertical enterprises are situated within the same tracking area and possibly within the same radio cells, usage of network slices may be problematic. If in this kind of network configuration, which is actually typical for macro networks, the communications service provider offers a specific network slice type/service to only selected customer(s), it is difficult to limit the usage of the offered network slice service beyond the limits of the intended customer(s) or the intended customers' premises.

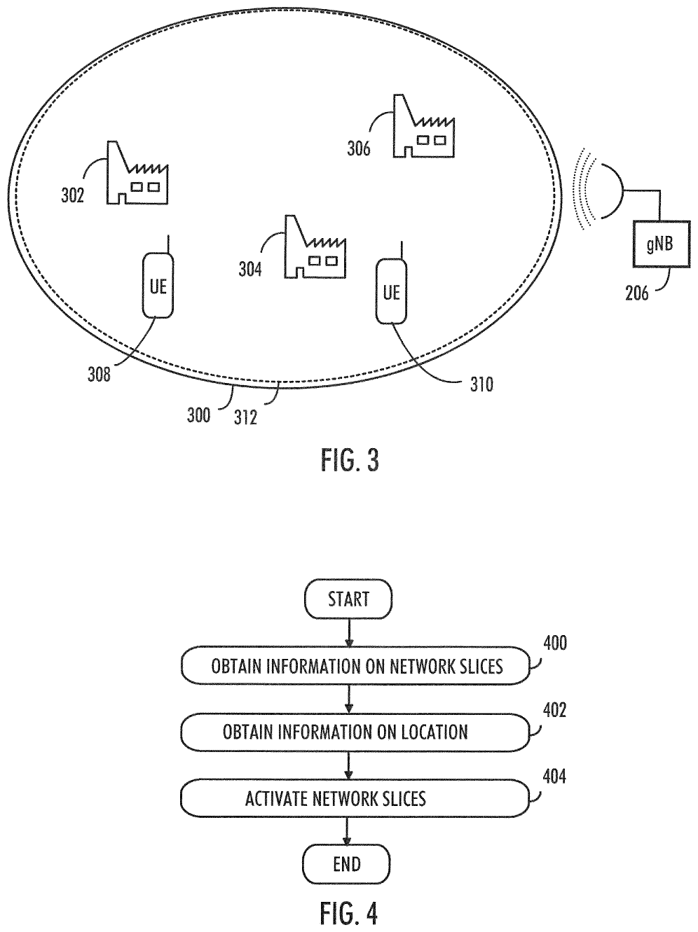

FIG. 3 illustrates an example. A base station 206 is serving a tracking area 300. The tracking area comprises in this simplified example three enterprises 302, 304 and 306. User terminal 308 is related to enterprise 302 and user terminal 310 is related to enterprise 304. Here the enterprise 304 has made a Service Level Agreement (SLA) with the communications service provider to obtain a network slice 312. However, as the network slice 312 is consistent throughout a tracking area 300, the user terminal 310 may access the slice in all of the TA coverage, also in other enterprises' premises, for instance.

The proposed solution provides an elegant method to restrict the use of a specific network slice type/service outside the limits of the agreed service area which can be a subset of the tracking area, for example.

FIG. 4 is a flowchart illustrating an embodiment. FIG. 4 illustrates examples of the operation of an apparatus or a network element configured to control access to network slices. In an embodiment, FIG. 4 illustrates the operation of Core Access and Mobility Management Function, AMF 210.

In step 400 of FIG. 4, the apparatus is configured to obtain information on one or more network slices of the communication system configured to serve user terminals and geographical areas where a network slice is available, the areas being within one or more tracking areas of the communication system.

In step 402 of FIG. 4, the apparatus is configured to obtain information on the geographical location of a user terminal.

In step 404 of FIG. 4, the apparatus is configured to activate one or more network slices for the user terminal if the user terminal is located within the geographical area where the network slices are available.

In an embodiment, the geographical area where a network slice is available is smaller than a tracking area of the communication system and located within one tracking area.

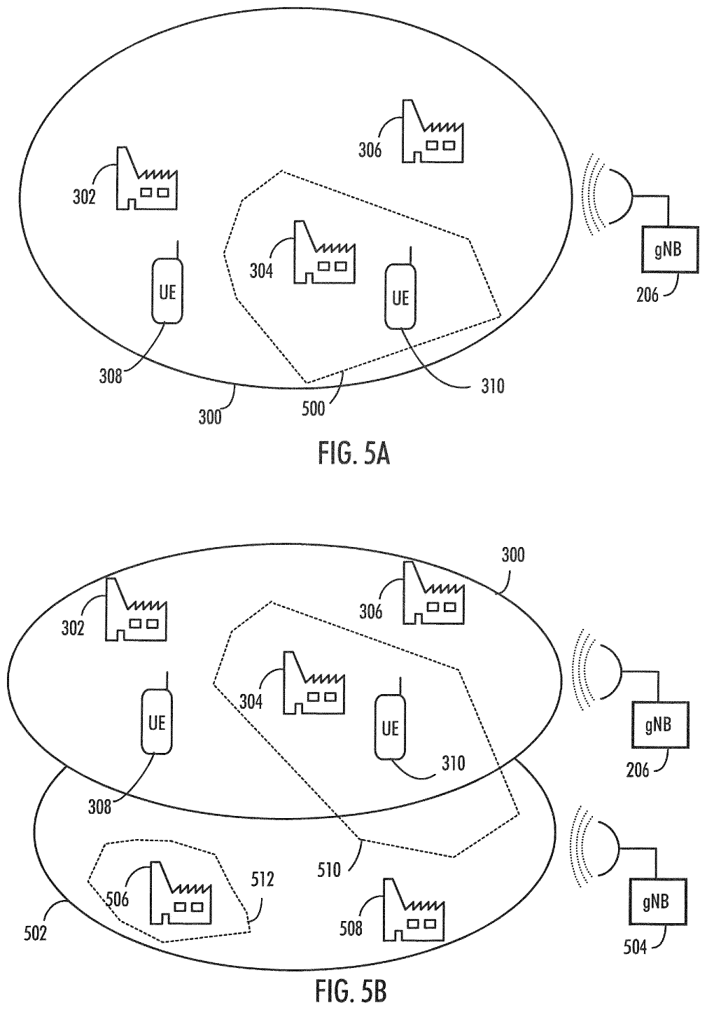

FIG. 5A illustrates an example. A base station 206 is serving a tracking area 300. The tracking area comprises in this simplified example three enterprises 302, 304 and 306 as in the example of FIG. 3. Here again the enterprise 304 has made a Service Level Agreement with the communications service provider to obtain a network slice 500. In this case, the geographical area covered by the network slice 500 differs from the tracking area and in this example is smaller than the single tracking area 300. In some embodiments, the geographical area covered by the network slice 500 may reach over a single tracking area to another tracking area.

In an embodiment, the geographical area where a network slice is available comprises areas of forming parts of more than one tracking area. The consistency over a tracking area present in prior art solutions does not apply. In an embodiment, the network slice may be defined for an arbitrary area instead of spanning whole tracking area or areas.

FIG. 5B illustrates an example. A base station 206 is serving a tracking area 300. The tracking area comprises in this simplified example three enterprises 302, 304 and 306 as in the examples of FIG. 3 and FIG. 5A. Here again the enterprise 304 has made an Service Level Agreement with the communications service provider to obtain a network slice 510. In this case, the geographical area covered by the network slice 510 spans to the area of tracking area 502 which in this example comprises enterprises 506, 508 and is served by base station 504.

It may be noted the above examples of FIGS. 5A and 5B are simplified. A tracking area may comprise more than one cell and may be server by a multitude of base stations, not just one as illustrated in FIGS. 5A and 5B for simplicity.

In an embodiment, it may also be noted that the geographical area covered by a network slice is not necessarily a single continuous area but may also be comprised of more than one separate geographical areas in one or more tracking areas. Thus in an embodiment, areas 510 and 512 may form the geographical area covered by a single network slice. Whenever a user terminal is inside these areas it may be connected to the network slice but when it moves outside these areas, it is disconnected from that particular slice.

In 5G based networks, a Single Network Slice Selection Assistance Information (S-NSSAI) identifies a Network Slice. An S-NSSAI comprises a Slice/Service type (SST), which refers to the expected Network Slice behavior in terms of features and services and a Slice Differentiator (SD), which is optional information that complements the Slice/Service type(s) to differentiate amongst multiple Network Slices of the same Slice/Service type. In an embodiment, when creating the network slices to its network, a communications service provider can create slices with dedicated zones based on for instance geographical coordinates and individualize these slices with dedicated SDs. In the example of FIG. 5A, one such area is the area 500. The Network Slice Selection Function 220 stores information on the network slice instances of the PLMN, including the S-NSSAI comprising SST and SD. In an embodiment, the service provider may configure in the NSSF a geographical area or zone (such as a coordinate route) specific to a certain defined network slice identified by an S-NSSAI. In an embodiment, the Single Network Slice Selection Assistance Information of a network slice comprises information that the use of the slice has geographical limitations.

The network slice instance selection for a user terminal may be triggered as part of the registration procedure by the first AMF 210, that receives the registration request from the user terminal. The AMF 210 retrieves the slices that are allowed by the user subscription and communicates with the NSSF 220 to select the appropriate Network Slice instance. During this process the AMF 210 may obtain location information of the user terminal and use this information when communicating with the NSSF in selecting the appropriate network slice instance or instances for the user terminal.

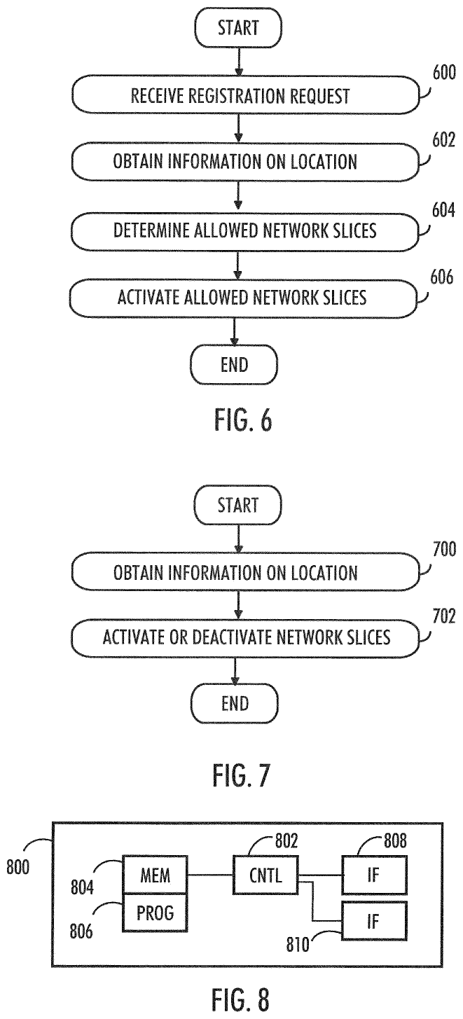

FIG. 6 is a flowchart illustrating an embodiment. FIG. 6 illustrates examples of the operation of an apparatus or a network element configured to control access to network slices. In an embodiment, FIG. 6 illustrates the operation of AMF 210.

In step 600 of FIG. 6, the apparatus is configured to receive a registration request from a user terminal.

In step 602 of FIG. 6, the apparatus is configured to obtain information on the geographical location of a user terminal. In an embodiment, the apparatus is configured to transmit a location services request to a Location Management Function, LMF 218, which then returns the result of the location service back to the apparatus.

In step 604 of FIG. 6, the apparatus is configured to obtain information on the network slices allowed for the user terminal based on the geographical location and the subscription data of the user terminal. The apparatus communicates with the Network Slice Selection Function, NSSF 220 in selecting the appropriate network slice instance for the user terminal.

In step 606 of FIG. 6, the apparatus is configured to activate the allowed network slices for the user terminal.

In an embodiment, the network slices the user terminal is utilising may change in time, especially if the user terminal is moving. The network may change the set of network slice(s) to which the user terminal is registered and provide the user terminal with a new Allowed NSSAI (which defines the network slices). The AMF 210 can at any time, provide the user terminal with a new Allowed NSSAI for the Serving PLMN. This procedure can be used in allowing and/or restricting the user terminal access to network slice instances based on the location of the user terminal and allowed geographical area for the particular network slice instance.

In an embodiment, the AMF 210 may receive a request for a location service associated with a user terminal from another entity. The entity may be for example the NSSF 220. In an embodiment, the AMF 210 itself may decide to initiate location service on behalf of a particular user terminal. The AMF then may send a location services request to a Location Management Function, LMF 218, which then returns the result of the location service back to the AMF 210.

The AMF compares the location of the user terminal to the allowed geographical areas of the network slice instances the user terminal is accessing and further controls the access of the user terminal to the network slice instances in question. If the user terminal has moved outside the allowed area of a network slice, the particular network slice is deactivated for the user terminal.

FIG. 7 is a flowchart illustrating an embodiment.

In step 700 of FIG. 7, the apparatus is configured to obtain information of a changed geographical location of a user terminal.

In step 702 of FIG. 7, the apparatus is configured to activate or deactivate a network slice for the user terminal based on the obtained information.

One of the advantages related to the some embodiments of the invention is that a Communications Service Provider can limit access to a certain specific network slice service/type to a confined geographical area and user terminals while subscribed to the same network slice service/type are not allowed to access the service if they are not located not within the area defined for the network slice.

For example, a Communications Service Provider may offer a specific Service Level Agreement, SLA, with slicing to a certain enterprise customer, but the cell coverage and tracking area cover a wider area and possibly multiple enterprises. Thus, it is important to be able to limit access to the slice only to the user terminals of that particular enterprise.

FIG. 8 illustrates an embodiment. The figure illustrates a simplified example of an apparatus applying embodiments of the invention. In some embodiments, the apparatus may be a Core Access and Mobility Management Function, AMF 210, or any other entity or network element of the communication system provided that the necessary inputs are available and required interfaces exists to transmit and receive required information.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 800 of the example includes a control circuitry 802 configured to control at least part of the operation of the apparatus. The control circuitry may be realized as a processor or more than one processors, for example.

The apparatus may comprise a memory 804 for storing data. Furthermore the memory may store software 806 executable by the control circuitry 802. The memory may be integrated in the control circuitry.

The apparatus may comprise one or more interface circuitries 808, 810. The interface(s) may connect the apparatus to other network elements of the communication system. The interface(s) may provide a wired or wireless connection to the communication system. The interface(s) may be operationally connected to the control circuitry 802.

The software 806 may comprise a computer program comprising program code means adapted to cause the control circuitry 802 of the apparatus to perform the embodiments described above and in the claims.

In an embodiment, the apparatus comprises at least one processor or control circuitry 802 and at least one memory 804 including a computer program code 806, wherein the at least one memory and the computer program code are configured, with the at least one processor, to cause the apparatus to carry out the functionalities of the apparatus 800 according to any one of the embodiments of described above and in the claims.

According to an aspect, when the at least one processor or control circuitry 802 executes the computer program code, the computer program code causes the apparatus to carry out the functionalities according to any one of the embodiments described above and in the claims.

According to another embodiment, the apparatus comprises the at least one processor or control circuitry 802 and at least one memory 804 including a computer program code 806, wherein the at least one processor or control circuitry 802 and the computer program code 806 perform the at least some of the functionalities of the apparatus 800 according to any one of the embodiments described above and in the claims. Accordingly, the at least one processor or control circuitry 802, the memory, and the computer program code form processing means for carrying out some embodiments of the present invention in the apparatus 800.

In an embodiment, the apparatus comprises means for obtaining information on one or more network slices of the communication system configured to serve user terminals and geographical areas where a network slice is available, the areas being within one or more tracking areas of the communication system, means for obtaining information on the geographical location of a user terminal, and means for activating one or more network slices for the user terminal if the user terminal is located within the geographical area where the network slices are available.

In an embodiment, the processes or methods described in above figures may also be carried out in the form of one or more computer processes defined by one or more computer program. A separate computer program may be provided in one or more apparatuses that execute functions of the processes described in connection with the figures. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1.-19. (canceled)

20. An apparatus in a communication system, the apparatus comprising
at least one processor;
at least one memory including computer program code;
characterized in that the at least one memory and the computer program code configured to, with the at least one processor, cause the apparatus at least to perform:
obtain (400) information on one or more network slices of the communication system configured to serve user terminals and geographical areas where a network slice is available, the areas being within one or more tracking areas of the communication system;
obtain (402) information on the geographical location of a user terminal; and
activate (404) one or more network slices for the user terminal if the user terminal is located within the geographical area where the network slices are available.

21. The apparatus of claim 20, the at least one memory and the computer program code configured to, with the at least one processor, cause the apparatus further to perform:
receive a registration request from a user terminal;
obtain information on the network slices allowed for the user terminal based on the geographical location and the subscription data of the user terminal;
activate allowed network slices for the user terminal.

22. The apparatus of claim 20, the at least one memory and the computer program code configured to, with the at least one processor, cause the apparatus further to perform:
obtain information of a changed geographical location of a user terminal;
activate or deactivate a network slice for the user terminal based on the obtained information.

23. The apparatus of claim 22, the at least one memory and the computer program code configured to, with the at least one processor, cause the apparatus further to perform:
receive a request to obtain updated information on the location of a user terminal;
request location data from a Location Management Function of the communication system.

24. The apparatus of claim 20, wherein Single Network Slice Selection Assistance Information of a network slice comprises information that the use of the slice has geographical limitations.

25. The apparatus of claim 20, the at least one memory and the computer program code configured to, with the at least one processor, cause the apparatus further to perform:
obtain information on available network slices from Network Slice Selection Function of the communication system.

26. The apparatus of claim 20, wherein a geographical area where a network slice is available is smaller than a tracking area of the communication system and located within one tracking area.

27. The apparatus of claim 20, wherein a geographical area where a network slice is available comprises areas of forming parts of more than one tracking area.

28. The apparatus of claim 20, wherein the geographical area covered by a network slice is comprised of more than one separate geographical areas in one or more tracking areas.

29. A method in a communication system, characterized by comprising:
obtaining (400) information on one or more network slices of the communication system configured to serve user terminals and geographical areas where a network slice is available, the areas being within one or more tracking areas of the communication system;
obtaining (402) information on the geographical location of a user terminal; and
activating (404) one or more network slices for the user terminal if the user terminal is located within the geographical area where the network slices are available.

30. The method of claim 29, further comprising:
receive a registration request from a user terminal;
obtain information on the network slices allowed for the user terminal based on the geographical location and the subscription data of the user terminal;
activate allowed network slices for the user terminal.

31. The method of claim 29, further comprising:
obtain information of a changed geographical location of a user terminal;
activate or deactivate a network slice for the user terminal based on the obtained information.

32. The method of claim 31, further comprising:
receive a request to obtain updated information on the location of a user terminal;
request location data from a Location Management Function of the communication system.

33. The method of claim 29, wherein Single Network Slice Selection Assistance Information of a network slice comprises information that the use of the slice has geographical limitations.

34. The method of claim 29, further comprising:
obtain information on available network slices from Network Slice Selection Function of the communication system.

35. The method of claim 29, wherein a geographical area where a network slice is available is smaller than a tracking area of the communication system and located within one tracking area.

36. The method of claim 29, wherein a geographical area where a network slice is available comprises areas of forming parts of more than one tracking area.

37. The method of claim 29, wherein the geographical area covered by a network slice is comprised of more than one separate geographical areas in one or more tracking areas.

38. A computer program comprising instructions for causing an apparatus of a communication system to perform any of the method steps of claim 29.
